(19) United States
(12) Patent Application Publication
(10) Pub. No.: US 2004/0011652 A1
(43) Pub. Date: Jan. 22, 2004

(54) Separation of particles using multiple conductive layers

(76) Inventor: Vincent Edward Bressler, Menlo Park, CA (US)

Correspondence Address: Vincent Bressler, 240 East Creek Drive, Menlo Park, CA, 94025, US

(21) Appl. No.: 10/197,538

(22) Filed: Jul. 16, 2002

(51) Int. Cl. G01N 27/26; G01N 27/447

(52) U.S. Cl. 204/643; 204/547

(57) ABSTRACT

An apparatus is disclosed which separates particles with different dielectric properties. The apparatus restricts the flow of some particles (27) through a three dimensional array of conductive layers (21) (22) while allowing other particles (25) to flow through. The separation process is controlled by electrical signal generators (23) that are connected to the conductive layers.

### REFERENCES CITED

U.S. Patent Documents

U.S. Pat. No. 6,387,707 May, 1999 Seul et al. 436/164

U.S. Pat. No. 6,310,309 March, 1999 Ager et al. 209/127.1

U.S. Pat. No. 6,264,815 January, 1999 Pethig et al. 204/547

U.S. Pat. No. 6,059,950 October, 1997 Dames et al. 204/547

U.S. Pat. No. 5,993,631 July, 1997 Parton et al. 204/547

U.S. Pat. No. 5,626,734 May, 1997 Docoslis et al. 204/547

U.S. Pat. No. 5,489,506 February, 1996 Crane 435/2

U.S. Pat. No. 5,454,472 February, 1994 Benecke et al. 209/127.1

Other References

Wang et al., “A Unified Theory of Dielectrophoresis and Traveling Wave Dielectrophoresis”, Journal of Physics D: Applied Physics, Vol 27, pp. 1571-1574, 1994

### FEDERALLY SPONSORED RESEARCH AND DEVELOPMENT

The invention was conceived and developed without aid of any government sponsorship.

### BACKGROUND OF THE INVENTION

1. Field of the Invention

This invention relates to the separation of particles with different dielectric properties.

2. Prior Art

A particle is a discrete structure that responds as one entity. Particles may be molecules, biological cells, or larger structures. Separation is the process of isolating distinct groups of particles from a mixture. Using the technique described in this specification, particles with different dielectric properties may be separated.

Dielectrophoresis may be used to separate living cells without harming the cells. Cells may be separated based on structural differences. For instance, changes in the ability of ions to penetrate the cell wall affect the dielectrophoretic response. Such structural changes are of interest to cell biologists.

A wide variety of techniques exist to examine cells. A successful new invention must complement the existing techniques. For instance, in order to be useful for drug screening, the separation technique must be scalable so that a large number of individual cell samples may be processed simultaneously. No previous invention employing dielectrophoresis to separate cells provides this capability.

U.S. Pat. No. 6,387,707 describes a method for collecting cells with different electrical properties at various positions on an electrode array. This method involves a single layer cell collection area with patterned electrodes above and below this area. This is expensive to produce, can only process a small number of cells at one time, requires complex control and does not integrated with existing drug screening equipment and methodologies.

U.S. Pat. No. 6,310,309 describes a method for separating particles using traveling wave dielectrophoresis. According to this method, particles flow in one direction and are exposed to an electromagnetic traveling wave in the orthogonal direction. This traveling wave will induce a force to move particles orthogonally with respect to the flow direction. Depending on their dielectric properties, some particles are forced in one direction, others in the opposite direction, thereby facilitating separation. This apparatus requires multiple conductive pathways running parallel to the direction of fluid flow. Therefore this technique is not scalable to a large number of independent fluid flows, as required by drug screening. The throughput of this device is directly proportional to the surface area of expensive micro-electrodes employed.

U.S. Pat. No. 5,626,734 describes an apparatus for separating particles using dielectrophoresis. According to this method, particles flow through a set of interdigitated electrodes. This apparatus is difficult to construct. The free-standing electrodes are fragile. The throughput of this device is directly proportional to the surface area of expensive, and in this case delicate, micro-electrodes employed.

U.S. Pat. No. 5,489,506 describes a method for separating particles using dielectrophoresis. According to this method, a stream of particles is diverted to various receptacles via dielectrophoresis. This technique requires separate electrical connections and signals for each stream of particles and is therefore not scalable for drug screening, were a large number of independent separations need to be performed simultaneously.

U.S. Pat. No. 5,454,472 describes a method for separating particles using dielectrophoresis. According to this method, a stream of particles is guided down a pathway. From this stream, a subset of particles is diverted using dielectrophoresis. This device is designed to process one continuous stream of particles and is not scalable for drug screening, were a large number of independent separations need to be performed simultaneously. Moreover this is two-dimensional separation device employing expensive micro-electrodes.

### SUMMARY OF THE INVENTION

The present invention is an apparatus that uses dielectrophoresis to separate particles by impeding the flow of some particles, but not others, through a three dimensional structure.

### OBJECTS AND ADVANTAGES OF THE INVENTION

The invention is immediately useful for applications involving the separation of biological cells or other small dielectric particles. The invention may be constructed of inexpensive and readily available materials, such as wire cloth instead of electrodes. No precise fabrication techniques or alignment procedures are required. Only one electrical signal generator is required for the most basic embodiment. Only one set of electrical connections is required to connect the signal generator for the most basic embodiment. Millions of particles may be processed simultaneously. The invention is compatible with standard mass screening formats such as ninety-six well. The invention is readily scalable to larger numbers of samples and particles. Further objects and advantages of the invention will become apparent from an inspection of the ensuing drawings and description.

### DESCRIPTIONS OF DRAWINGS

FIG. 1 is schematic illustration of the most basic embodiment of the invention.

FIG. 2 is a schematic illustration of an embodiment of the invention with three signal generators.

FIG. 3 is a schematic illustration of an embodiment of the invention with four signal generators.

FIG. 4 is a graph showing several signals that may be produced by a signal generator.

FIG. 5 is a graph showing the relationship between the phase offset signals that create the traveling wave.

FIG. 6 shows a ninety-six well embodiment of the invention without electronics.

FIG. 7 shows the stack of conductive and insulating layers for a ninety-six well system.

FIG. 8 shows a ninety-six well embodiment of the invention with three signal generators.

FIG. 9 shows an idealized plot of the dielectrophoretic frequency response of one particle.

FIG. 10 shows a ninety-six well embodiment of the invention with more than four electrical connections.

FIG. 11 shows an embodiment of the invention for continuous mass separation of particles into two streams.

### DESCRIPTION OF REFERENCE NUMBERS

21—Upstream conductive layer for most basic embodiment

22—Downstream conductive layer for most basic embodiment

23—Signal generator for most basic embodiment

25—Suspended particle.

27—Trapped particle

29—Forward direction for particle movement

30—Reverse direction for particle movement

31—Downstream signal generator for creating traveling wave

33—Upstream signal generator for creating traveling wave

35—Summing amplifier

37—Analog signal inverter or one hundred and eighty-degree phase shifter

39—Zero degree phase offset conductive layer for traveling wave

41—Ninety degree phase offset conductive layer for traveling wave

43—One hundred and eighty degree phase offset conductive layer for traveling wave

45—Two hundred and seventy degree phase offset conductive layer for traveling wave

47—Upstream signal generator in four signal generator embodiment

49—Downstream signal generator in four signal generator embodiment

51—Time plot of single frequency voltage signal

53—Time plot of dual frequency, amplitude modulated voltage signal

55—Time plot of dual frequency shift voltage signal

61—Time plot of zero degree phase offset voltage signal

63—Time plot of ninety degree phase offset voltage signal

65—Time plot of one hundred and eighty degree phase offset voltage signal

67—Time plot of two hundred and seventy degree phase offset voltage signal

71—Top of standard ninety-six well liquid interface

72—Clamping mechanism to hold conductive layers together

73—Fluid receptacle for ninety-six well embodiment of the invention

74—Upstream fluid chamber for ninety-six well embodiment of the invention

75—Connection tab on zero degree phase offset conductive layer for traveling wave

76—Downstream fluid chamber for ninety six well embodiment of the invention

77—Connection tab on ninety degree phase offset conductive layer for traveling wave

79—Connection tab on one hundred and eighty degree phase offset conductive layer for traveling wave

81—Connection tab on two hundred and seventy degree phase offset conductive layer for traveling wave

83—Insulating layer for standard ninety-six well embodiment

85—Conductive strip that ties together the connection tabs on the zero degree phase offset conductive layers

86—Signal frequencies that repel a particular particle from a conductive layer

87—Signal frequencies that attract a particular particle to a conductive layer

88—Cross over frequency where a particle is neither attracted nor repelled from a conductive layer

89—Additional connection tab, allows more signals to be introduced to the system

91—Particle separation system with one input port and one output port

93—Single input port for separation system

95—Single output port for separation system

97—Primary input valve for two port separation system

99—Secondary input valve for two port separation system

101—Secondary output valve for two port separation system

103—Primary output valve for two port separation system

105—Primary input stream, contains particles, for two port separation system

107—Secondary input stream, contains no particles, for two port separation system

109—Primary output stream, contains no blocked particles, for two port separation system

111—Secondary output stream, contains only previously blocked particles, for two port separation system

### Structural Description of the Invention

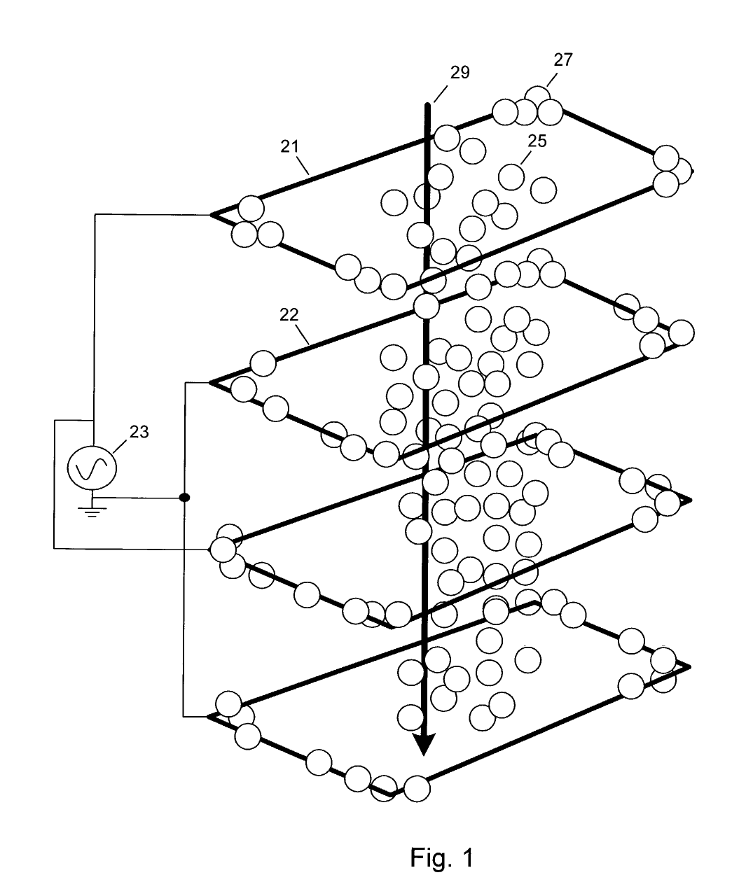

FIG. 1 illustrates the most basic embodiment of the invention. Two conductive layers 21, 22 are connected to a time varying voltage signal generator 23. Particles move through the conductive layers 29 via bulk fluid flow. Some particles 27 are attracted to the conductive layers and become trapped. Other particles 25 are repelled from the conductive layers and move through the apparatus.

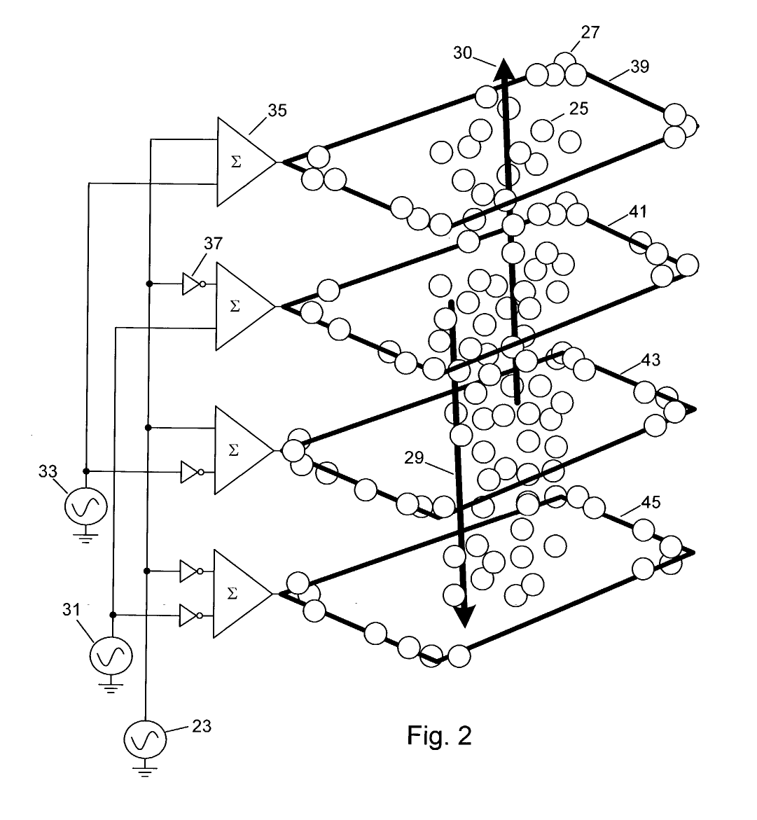

FIG. 2 illustrates an embodiment of the invention that includes three voltage signal generators. One signal generator 23 provides voltage signals that are one hundred and eighty degrees out of phase to alternating conductive layers. This two-phase signal serves to attract or repel particles with respect to the conductive layers. The other two signal generators 31,33 provide voltage signals that are ninety degrees phase offset between each conductive layer 39, 41, 43, 45. This four-phase signal sets up a traveling wave that forces particles to move in either the forward direction 29 or the reverse direction 30. Analog inverters 37 are used to perform one hundred and eighty degree phase shifts of voltage signals. Summing amplifiers 35 are used to sum voltage signals before they are connected to the respective conductive layers.

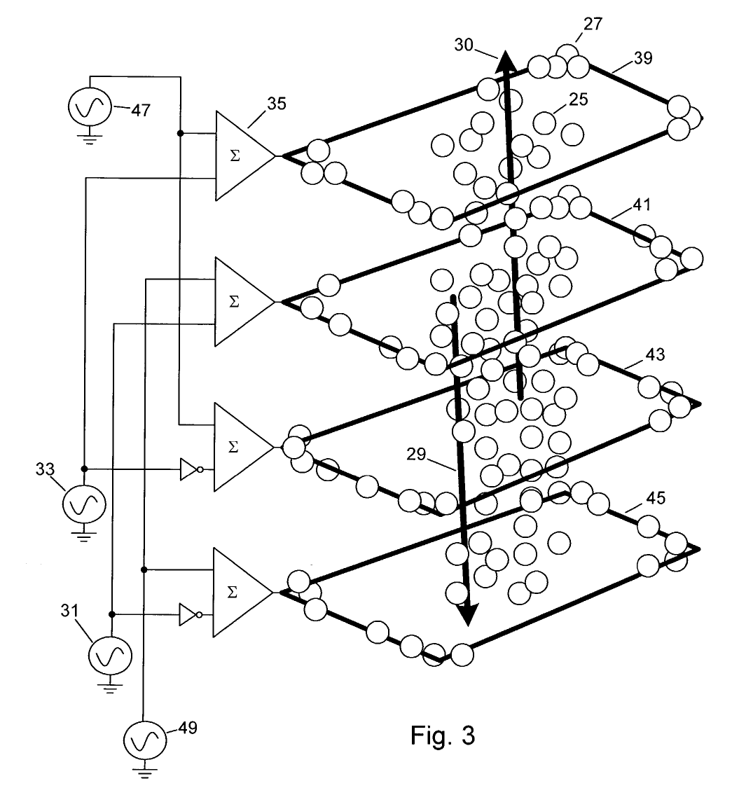

FIG. 3 illustrates an embodiment of the invention that includes four voltage signal generators. Two signal generators 47,49 provide a signal to attract and repel various particles. These two signal generators may have different frequencies. Using two frequencies provides more flexibility in selecting which particles are trapped by the conductive layers. Otherwise, this embodiment is identical to the embodiment illustrated in FIG. 2.

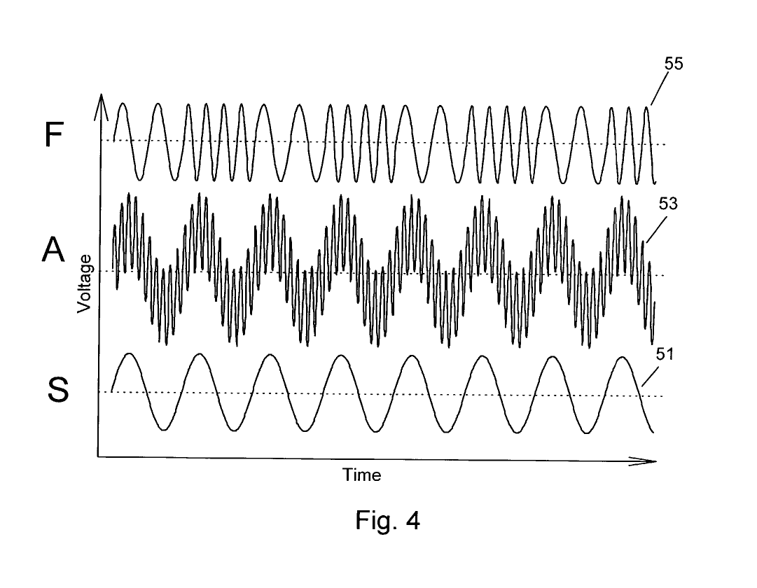

FIG. 4 is a time plot of voltage signals. S 51 is a single frequency signal that may be produced by any standard signal generator. A 53 is an amplitude modulated signal that combines two single frequency signals. Many commercial signal generators generate this type of signal. Signal A may be applied to alternating electrodes 21,22 from a standard signal generator 23 in order to attract or repel particles with respect to the conductive layers. The use of two or more frequencies provides more precise particle selection. F 55 is a frequency shift modulated dual frequency signal that may be produced by many commercially available signal generators. Frequency shift and amplitude modulation are but two methods that may be used to create signals with more than one frequency.

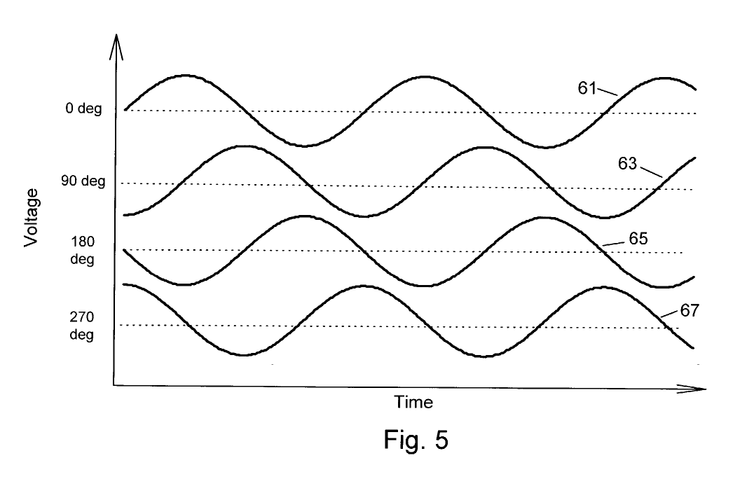

FIG. 5 is a time plot of four phase offset signals 61, 63, 65, 67 that may be applied to alternating conductive layers 39, 41, 43, 45. The presence of these signals produces a traveling wave between the four conductive layers that forces particles to move in either the forward direction 29 or the reverse direction 30 depending on their dielectric properties. Some commercially available signal generators provide a ninety degree phase offset output 31 with respect to the primary signal 33 at the same amplitude and frequency. Using these two signals and analog inverters 37 it is possible to generate all four required phases. These signals may be combined using summing amplifiers 35 with the signals 23 that provide for repulsion from or attraction to the conductive layers.

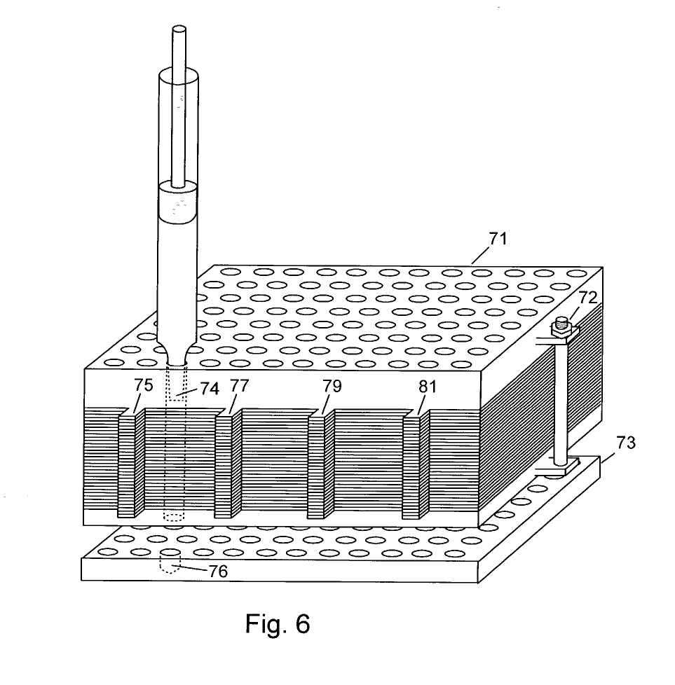

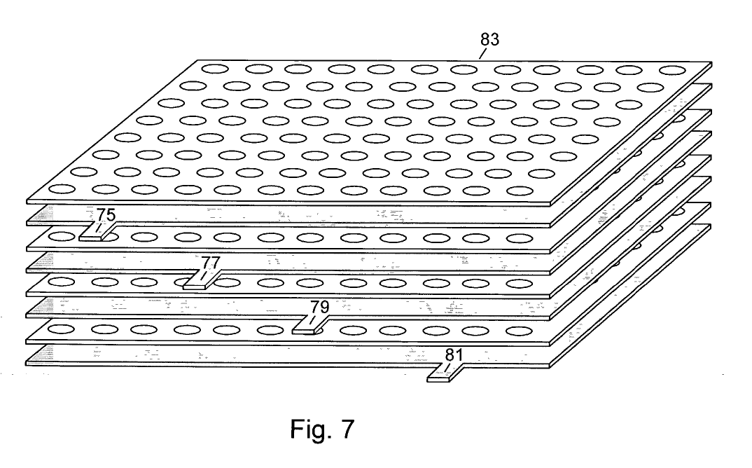

FIG. 6 shows a ninety-six well embodiment of the invention with connection tabs for four independent signals 75, 77, 79, 81, a top interface 71 to a standard ninety six well automated pipetting device, and a bottom receptacle 73 to receive fluid after it passes through the conductive layers. The top interface 71 includes ninety-six upstream fluid chambers 74 where fluid is pipetted into the system. The bottom receptacle 73 contains ninety-six downstream fluid chambers 76 where fluid is collected after the separation process. The top interface 71 and bottom receptacle 73 may be made of plastic with drilled holes. Electronics are not shown in FIG. 6. A simple clamping mechanism 72 holds the conductive layers (FIG. 7) 75, 77, 79, 81 together.

FIG. 7 shows alternating layers of insulator 83 and conductor with connection pads 75, 77, 79, 81. The connection pads may be used to distribute a common electrical signal to many dispersed layers in a stack. The insulator may be made of 50 um thick polyimide film, available from DuPont corp. Stacks of these sheets may be cut to shape and drilled with the standard ninety-six well pattern in order to produce the insulating layers. The conductive layers are made of plain weave stainless steel 200 mesh wire cloth which is available from many vendors. This provides square openings between wires that are about 70 um on a side. The wire cloth and polyimide material may be cut to shape with any hardened steel edged cutting tool. A simple clamping mechanism (FIG. 6) 72 may be used to align and hold the layers together. Precise alignment of the layers is not required. In particular, it is not necessary to align the layers of wire mesh. The ninety-six holes through the insulating layers must be aligned so that fluid stays in each channel.

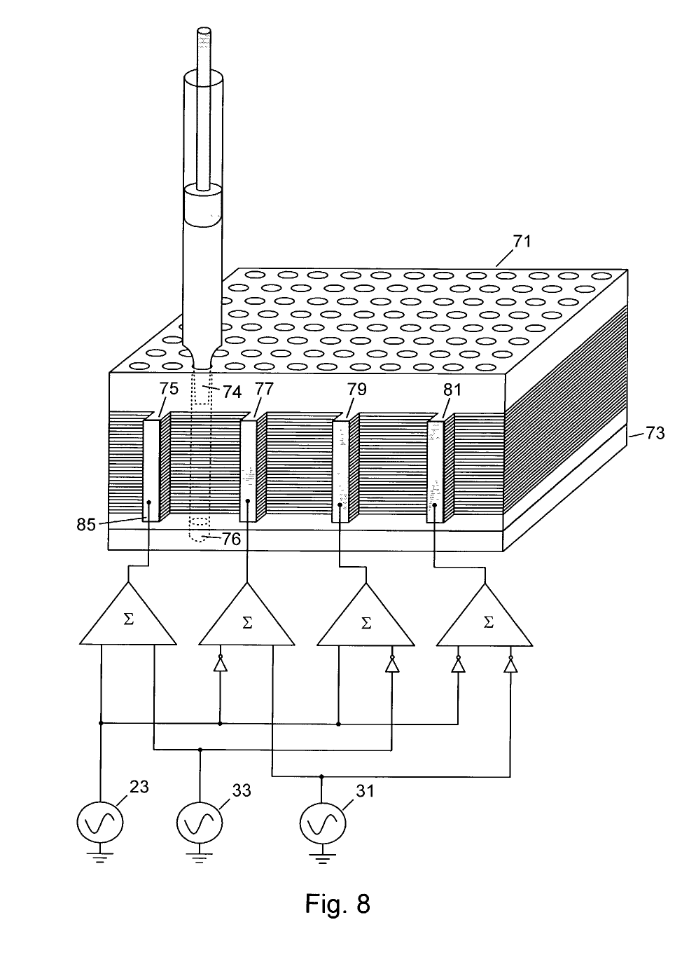

FIG. 8 shows a ninety-six well embodiment of the invention including soldered on connection strips 85 to connect all of the conductive layers for each tab together 75, 77, 79, 81. The connection strips may be made of any thin strip of metal that can be soldered on to the array of protruding tabs 75, 77, 79, 81. A schematic diagram of the electronics for the three signal generator embodiment is also shown along with the electrical connections to the conductive layers.

### Operational Description of the Invention

Particles must be suspended in a fluid with the proper characteristics. The general requirement is that the particles be in a fluid with different dielectric properties than the interior of the particle. When the particles are biological cells, it is sufficient to suspend the cells in a fluid with low electrical conductivity, on the order of 1000 uS/cm or less. When the cells are baker's yeast (Saccharomyces Cerevisiae), use the following procedure: Add de-ionized water to dried yeast in one beaker. Pipette about 5 ml of this high concentration activated yeast slurry into 400 ml of de-ionized water in another beaker. Then measure the conductivity, using a standard conductivity meter, of the diluted solution in the second beaker. A add small amounts of salt until the conductivity is on the order of 200 uS/cm. Place a drop of the 200 uS/cm fluid onto a microscope slide and place a cover slip on top of the drop. Adjust the microscope objective to 20×. If between 100 and 300 cells are visible in the field of view, then the diluted solution is ready. Otherwise, adjust the cell concentration of the dilute solution by adding water or by adding more of the high concentration yeast slurry. Adjust the conductivity by adding salt or water if necessary.

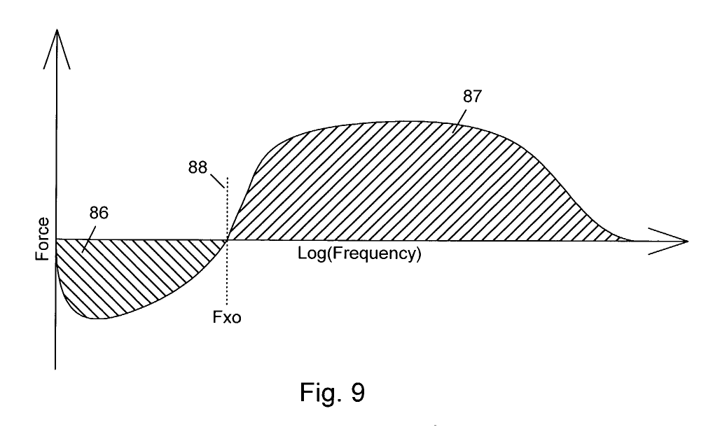

FIG. 9 shows an idealized plot of the frequency response of one particle. This frequency response is consistent with the most basic setup shown in FIG. 1. For low frequencies, up to the cross over frequency 88, the particle is repelled 86 from the conductive surfaces 21,22. For higher frequencies the particle is attracted 87 to the conductive surfaces. Particles with the same dielectric characteristics will have approximately the same frequency response curve. Groups of particles with different dielectric properties may be separated using the apparatus.

A procedure to perform separation of cells with cross over frequency 88 above and below 1 MHz at 200 uS/cm using the setup depicted in FIG. 8 is as follows. Turn on the voltage signal generator for the most basic embodiment 23 to 2V single frequency at 1 MHz. Turn the other two signal generators 31,33 to zero volts. Use a standard automated pipetting system to dispense fluid into the wells such that the fluid flow rate is 50 um/s. For ninety-six well format, this is a flow rate of approximately 1 ul/s. Stop dispensing fluid. Remove the bottom receptacle 73 that now contains particles with cross over frequencies greater than 1 MHz. Insert a clean bottom receptacle. Set the signal generator 23 voltage to zero. Use the pipetting system to dispense clean, no cells, water with conductivity 200 uS/cm at 50 um/s flow rate. The bottom receptacle 73 now contains cells with cross over frequencies less than 1 MHz.

When using all three signal generators 23, 31, 33 as shown in FIG. 8, the amplitude must be the same for the four phase signals 61, 63, 65, 67. DC offsets for all signals reaching the conductive layers must not exceed 20 mV. This may be accomplished by adjusting the summing amplifiers 35 or by using inline capacitors. Signal frequencies to separate various cell types should be determined experimentally before using this system. This characterization process is described in U.S. Pat. No. 6,264,815 January, 1999 Pethig et al. Required signal frequencies are in the range of 1 KHz to 100 MHz. Signal frequencies and amplitudes must be determined for each particle type processed. Maintaining a bulk fluid flow rate of 50 um/s assures that particles remain trapped on the conductive layers. Use slower flow rates, on the order of 20 um/s, when the traveling wave signal 31,33 moves particles against the flow.

### Alternate Embodiments of the Invention

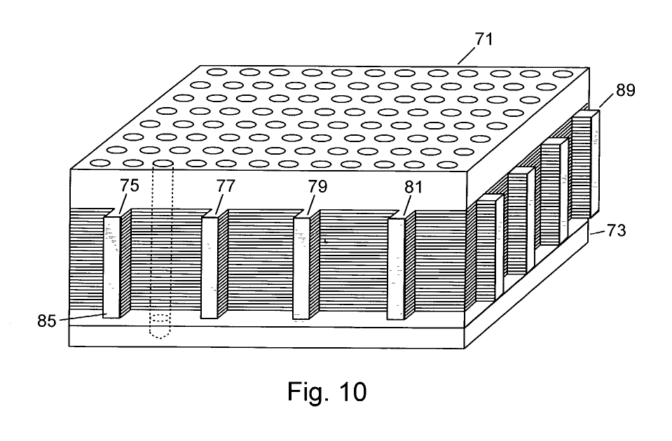

FIG. 10 shows a ninety-six well embodiment of the invention with extra connection pads 89. Fifty or more connection pads may be added to the apparatus without complicating the fabrication process. Each connection pad allows an independent electrical signal to be added to one or more layers. Adding more signals to the apparatus may increase the efficiency of separation.

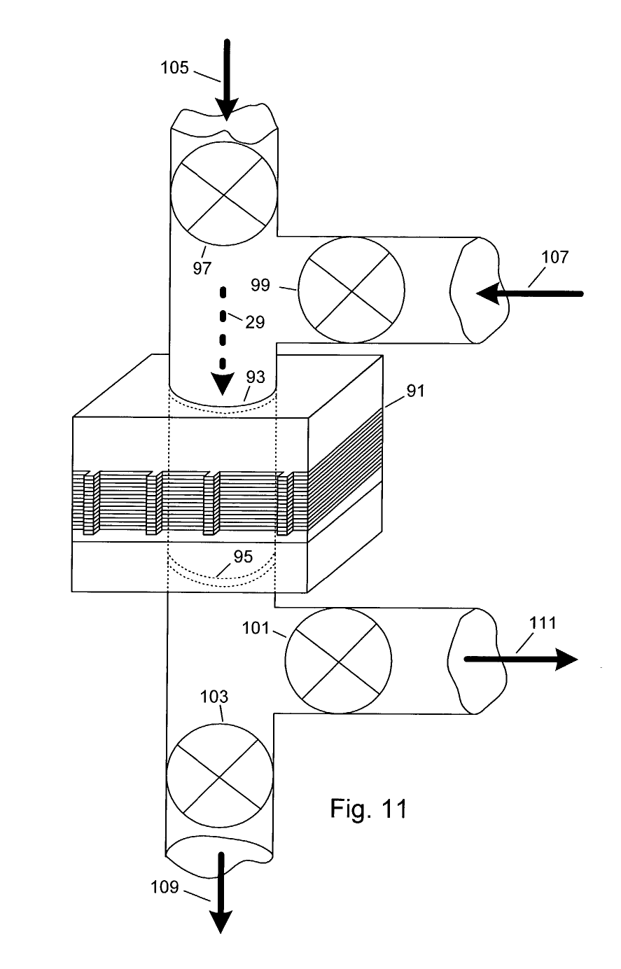

FIG. 11 shows an embodiment of the invention with a single input port 93 and a single output port 95. The primary input stream 105 contains fluid with particles and is gated by a valve 97. The secondary input stream 107 contains no particles and is gated by a valve 99. The primary output stream 109 contains only particles that pass through the separation system 91 and is gated by a valve 103. The secondary output stream 111 contains only particles that are blocked by the separation system 91 when its electrical signals are turned on. This stream is gated by a valve 101. Two types of particles may be separated. The steps are as follows: Open primary input valve 97 and primary output valve 103. Close the secondary input valve 99 and the secondary output valve 101. Turn on electrical signals to the system. Allow fluid to flow from the primary input 105 stream to the primary output stream 109 until the number of particles trapped in the apparatus 91 nears its capacity. The capacity of the apparatus for any particular filtering process must be determined experimentally by inspecting particles coming out of the system. Close the primary valves 97,103. Turn off the electrical signal. Open the secondary valves 99,101. Allow fluid to flow until the particle count in the secondary output stream 111 drops to zero or an acceptably small number. The time required to flush the system must be determined experimentally by observing particle count in the secondary output stream 111.

The system shown in FIG. 11 may be expanded to include more input and output valves. This will allow the combination and separation of more than two types of particles.

### Theory of Operation

The invention works by the following two mechanisms:

First, electromagnetic fields created by the primary signal generator 23 between alternate conductive layers 21,22 cause passing particles to be either attracted 27 or repelled 25 from the conductive surfaces. Whether a particle is attracted or repelled for a particular frequency depends on the dielectric properties of the particle. Multiple frequency components may be combined to attract or repel the desired subset of particles. U.S. Pat. No. 6,264,815 January, 1999 Pethig et al. uses this dielectrophoretic force to move particles and describes the theory.

Second, electromagnetic fields created by the secondary signal generators 31,33 provide a force that either propels particles in the upstream direction 30 or the downstream direction 29. Whether a particle is propelled upstream or downstream for a particular traveling wave frequency depends on the dielectric properties of the particle. Wang et al., “A Unified Theory of Dielectrophoresis and Traveling Wave Dielectrophoresis”, Journal of Physics D: Applied Physics, Vol 27, pp. 1571-1574, 1994 provides a description of the theory.

### Conclusions, Ramifications and Scope of Invention

The invention may be scaled to separate billions of particles per minute. Previous inventions employ a two dimensional geometry of electrodes using dielectrophoresis to separate particles. This invention uses all three spatial dimensions, where the spacing between conductive layers serves the same purpose as the spacing between electrodes in the two dimensional case. This invention does not require any components that must be constructed using photolithography. Furthermore the number of particles processed by this system is hundreds or thousands of time greater than for two-dimensional systems using the same principles. Therefore, the cost per particle processed by this system is potentially millions of times less than for two-dimensional systems.

While the above description contains many specific details, these should not be construed as limitations on the scope of the invention, but rather as examples of various embodiments of the invention. Many other variations are possible.

I claim:

1. A particle separation device, comprising:
a. two or more layers of electrically conductive material with openings through which particles move during the separation process, and
b. a means to apply time varying voltage to one or more of said layers,
whereby some particles move through said electrically conductive layers and others do not.

2. The device of claim 1 wherein some particles become trapped on the surface of one or more of said conductive layers and other particles move through said conductive layers in the downstream direction.

3. The device of claim 1 wherein some particles move through said conductive layers in the downstream direction and the remaining particles move through said conductive layers in the upstream direction.

4. The device of claim 1 wherein some particles become trapped on the surface of one or more of said conductive layers, some particles move through said conductive layers in the upstream direction and the remaining particles move through said conductive layers in the downstream direction.

5. The device of claim 1 wherein an electromagnetic traveling wave is created by applying phase offset time varying voltages to subsequent conductive layers.

6. The device of claim 1 wherein said time varying voltage contains more than one frequency component.

7. The device of claim 1 wherein time varying voltages with various frequency components are applied to various electrically conductive layers.

8. The device of claim 1 wherein time varying voltages with various amplitudes are applied to various electrically conductive layers.
